(19) United States
(12) Patent Application Publication
(10) Pub. No.: US 2011/0301912 A1
(43) Pub. Date: Dec. 8, 2011

(54) PROVIDING LOCATION ESTIMATES BASED ON A LOCATION CLASSIFICATION CATEGORY

(76) Inventors: Santosh PANDEY, Santa Clara, CA (US); Nirmala Venkataramani, Campbell, CA (US); Karthikeyan Ganesan, San Jose, CA (US); Vikram Jayaraman, Campbell, CA (US)

(21) Appl. No.: 12/795,915

(22) Filed: Jun. 8, 2010

(51) Int. Cl. G06F 15/00

(52) U.S. Cl. 702/150

(57) ABSTRACT

In an example embodiment, there is described herein an apparatus comprising an interface and logic operable receive data from a device via the interface. The logic is operable to estimate a location of the device based on data received via the interface based on a first (e.g. default) location classification. The logic is further operable to estimate a location of the device based on data received via the interface based on a second location classification responsive to a predefined trigger.

### TECHNICAL FIELD

The present disclosure relates generally to tracking the location of devices.

### BACKGROUND

Determining the location of a device generally requires additional network resources such as additional computation resources and packet transmissions. In some networks, a device's location is estimated by a central server (sometimes referred to as a Location Server or Location Services Server), which may be tracking the location of thousands of devices. Location estimation may utilize any one or more of the following resources: client/infrastructure packet transmissions/receptions, client battery life, additional computation at the client and/or server side, and/or network overhead such as bandwidth.

### BRIEF DESCRIPTION OF THE DRAWINGS

The accompanying drawings incorporated herein and forming a part of the specification illustrate the examples embodiments.

FIG. 1 illustrates an example of an apparatus for providing location estimates based on a location classification.

FIG. 2 illustrates a network employing the apparatus described in FIG. 1

FIG. 3 illustrates an example of a computer system upon which an example embodiment may be implemented.

FIG. 4 illustrates an example of a methodology for providing location estimates based on a location classification.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising an interface and logic operable receive data from a device via the interface. The logic is operable to estimate a location of the device based on data received via the interface based on a first (e.g. default) location classification. The logic is further operable to estimate a location of the device based on data received via the interface based on a second location classification while a predefined condition exists.

In accordance with an example embodiment, there is disclosed herein a method determining a current location classification for a device. A first location estimating technique is employed to provide a current location estimate for the device responsive to determining the device is in a first location classification category. A second location estimating technique is employed to provide the current location estimate for the device responsive to determining the device is in a second location classification category, wherein the device is determined to be in the second location classification responsive to a predefined event.

In accordance with an example embodiment, there is disclosed herein logic encoded in at least one tangible media for execution by a processor and when executed operable to employ a first location estimation technique for estimating a location of a device selected from a plurality of location estimation techniques based upon a first location estimation category associated with the device. The logic is further operable to employ a second location estimation technique selected from the plurality of location estimation techniques while a predefined condition exists.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Described in example embodiments herein are techniques for determining the location of devices on a network where the resources employed for determining the location of each device is a function of the device's classification and/or priority. For example, not all devices may need to be located very accurately all of the time and resources can be allocated accordingly. For example, when less accuracy for a device is sufficient, fewer resources can be employed. Devices may be categorized/prioritized based on device capability (such as available processing resources and/or supported protocols), battery life, and/or rule based (for example the priority may change in response to a predefined event).

In an example embodiment, the classification of a device may be set by an administrator based on the importance of the device. In particular embodiments, the classification of the device is static. For example, in a hospital, determining the location of an oxygen tank may be more important than determining the location for a wheelchair. As will be described herein infra, the device classification and/or priority may change as a response to a predefined event.

In an example embodiment, the classification of a device depends on the device's capabilities such as protocols supported by the device. For example, if a device advertises 802.11v location track notification capability, the network will automatically assign a higher priority to the device than for devices that do not have 802.11v track notification capability. The device may be assigned the higher priority as long as the network has sufficient resources are available

In an example embodiment, the classification of a device may depend on the remaining battery life of the device. For example, a device that is capable of providing highly accurate location data may be temporarily downgraded if the remaining battery life falls below a predefined threshold; however, the device's classification may also be temporarily reinstated in response to a predefined event such as receiving a request for the device's location.

In an example embodiment, the location priority and/or classification of a device may be rule based. For example, the classification of a device may change based on a predefined event. As one example, if excessive location jitter is detected (e.g. a frequent change in location over time), the priority of the device may be temporarily increased. As another example, if a dual band (for example WiFi and cellular capable) mobile device connected to a Voice over Internet Protocol (VoIP) call is detected in proximity of a WiFi coverage area, the priority of the device can be automatically increased.

In an example embodiment, the location classification and/or priority changes as a function of time of day. In particular embodiments, the importance of tracking some devices may vary by time of day. For example, in a warehouse setting, the location of Radio Frequency Identification (RFID) scanners may be more critical when workers are starting a new shift.

In an example embodiment, the location classification for a device may change depending on where the device is currently located. For example, in a retail environment, the location of a customer may increase in importance to a floor manager when a customer enters an area where the customer ordinarily purchases goods.

In an example embodiment, the location priority and/or classification of a device may increase in response to a request for locating the device. For example, while no pending requests are being processed, the location of a device may be low priority, thus fewer resources may be employed to track the device, whereas in response to a request for the device's location, the location priority of the device may temporarily be increased to employ greater resources to obtain a more accurate location of the device.

In an example embodiment, different options are available for providing a location estimate of a device depending on the location priority and/or classification of the device. For example, periodicity, protocol (or type of message), algorithm, and/or number of interfaces employed may be varied.

For example, the accuracy of location estimates can be varied by varying the periodicity of the location messages and calculations. The frequency of probe requests that a device sends can be increased to provide more frequency location updates, and hence provide more accurate location data. More frequent location updates can improve accuracy since filtering of location data may be employed to remove location jitter and more frequent updates reduces location error due to latency.

In an example embodiment, the accuracy of location estimates for a device can be based on the type of messages or protocol employed by the device. For example, a device may be compatible with the 802.11k standard's beacon request/report measurements (802.11k), and/or the 802.11v location track notification packets. For example, 802.11k employs Received Signal Strength Indication (RSSI) data acquired by the device for access points (APs) detected by the device to determine the device's location. For 802.11v compatible devices, the device can send 802.11v location track notification packets providing an infrastructure node with additional information to estimate the device's location. If the device supports both 802.11k and 802.11v, the device may use 802.11k when low resolution is sufficient and 802.11v when higher accuracy is desired.

In an example embodiment, different algorithms may be employed depending on the importance of the location of the device. For example, locations of the strongest access point (AP) signals may be reported for devices with very low priority. However, if a more accurate location for the device is desired, more complex algorithms such as maximum likelihood and Kalman filtering may be employed which have higher computational and storage requirements.

In an example embodiment, the number of interfaces employed by a device may be varied based on the desired accuracy of the device's location. For example, many wireless devices have multiple wireless interfaces, such as cellular telephone, BLUETOOTH, WIFI, infrared (IR), etc. Signals may be sent on the additional interfaces to achieve higher accuracy when desired.

Table 1 below illustrates an example illustrating how different location accuracy priorities (in this example in descending order is from L_{—}1 to L_{—}4) can be employed for providing location data. In the illustrated example, location estimation for each classification is a function of the protocol (type of message) and periodicity.

| Classification | Protocol (Type of Message) | Periodicity |
|---|---|---|
| L_1 | 802.11v location track | every 5 seconds |
| | notification | |
| L_2 | 802.11k beacon request- | every 5 seconds |
| | response measurement | |
| L_3 | 802.11v location track | every 5 minutes |
| | notification | |
| L_4 | 802.11k beacon request- | every 5 minutes |
| | response measurement | |

In the above example, L_{—}1 and L_{—}2 both have the same periodicity; however 802.11v location track notification protocol has greater accuracy than 802.11k beacon request-response measurements, so devices in category L_{—}1 devices would have the best location estimates, followed by devices in L_{—}2. Categories L_{—}3 and L_{—}4 estimate their location every 5 minutes as opposed to every 5 seconds, thus providing even less accurate location estimates, but consuming less mobile device and network resources than devices in categories and L_{—}2.

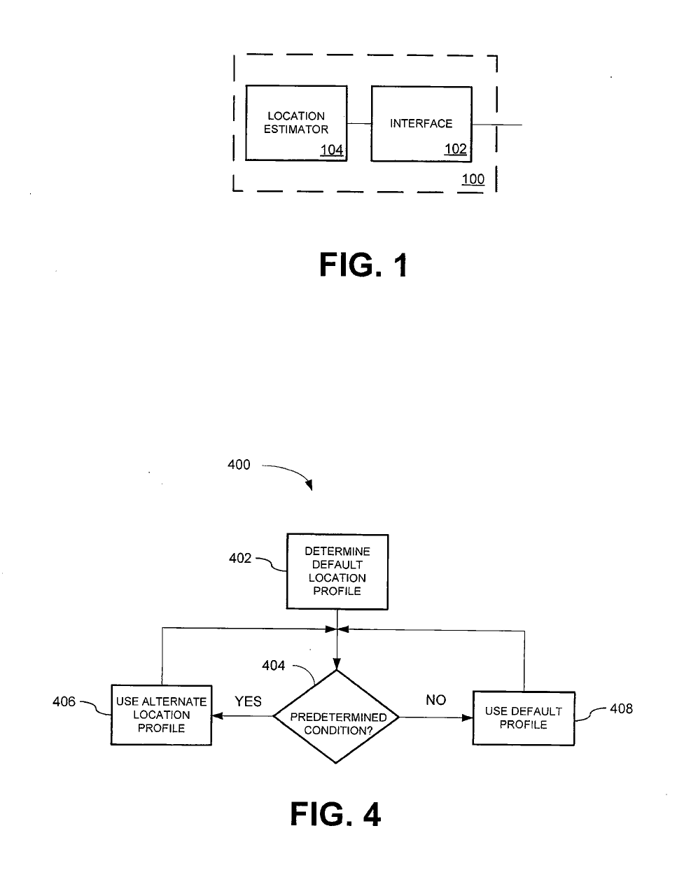

FIG. 1 illustrates an example of an apparatus for 100 providing location estimates based on a location classification. Apparatus 100 comprises an interface 102 for communicating with an external device. For example, interface 102 may receive data from an external device for estimating the external device's location. In an example embodiment, interface 102 is also employed to communicate instructions to an external device. For example, interface 102 may be employed to instruct a device which type of message (or protocol such as 802.11k, 802.11v, etc.) to use to acquire data for determining a location estimate and/or a periodicity for estimating the device's location.

Location estimator 102 estimates a device's location based on a priority and/or category. Location estimator 102 may suitably be employed to implement an example embodiment described herein. In particular embodiments, location estimator 102 estimates a device's location based on a first (e.g. default) location classification category, and is further operable to estimate the location of the device based on a second location classification category while a predefined condition exists. In an example embodiment, location estimator 102 is configured to obtain data to estimate the location of an external device via interlace 102.

Location estimator 102 may suitably comprise logic for performing the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

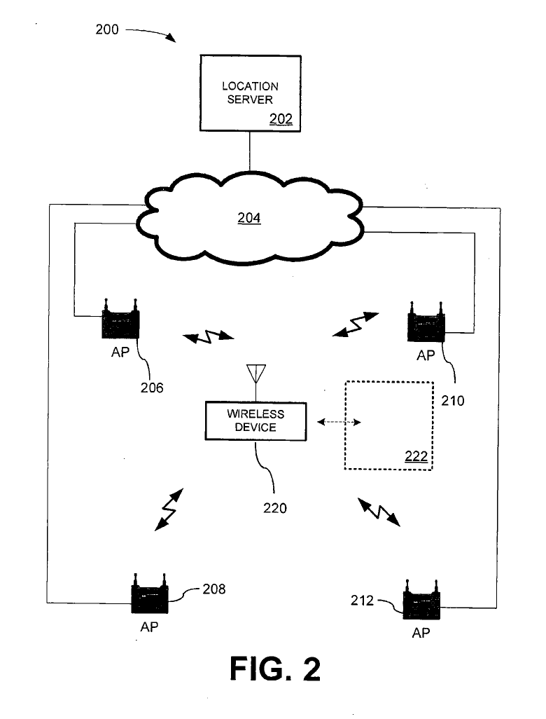

Referring to FIG. 2 with continued reference to FIG. 1, there is illustrated a network 200 employing apparatus 100 for providing location estimates based on a location classification. In the illustrated example, a location server 202 is employed to estimate the location of wireless device 220. In an example embodiment, location server 202 suitably comprises apparatus 100. Location estimation logic 104 may determine a location classification category (or priority) for wireless device 220 and may provide estimates of wireless device 220's location based on wireless device 220's current classification category. Location server 202 is coupled via network 204 to access points 206, 208, 210, 212 that can communicate with wireless device 220. At any given time any of or a combination of APs 206, 208, 210, 212 may receive signals from wireless device 220 and/or wireless device 220 may receive signals from any one or combination of APs 206, 208, 210, 212. The example illustrated has four access points, and one wireless device; however, those skilled in the art should readily appreciate that the number of APs and wireless devices selected for FIG. 2 was merely for ease of illustrating example embodiments described herein and that a network implementing an example embodiment described herein may suitably have any physically realizable number of APs and wireless devices.

In an example embodiment, the second location classification category (or priority) provides a more precise location estimate than the first location classification category. In another example embodiment, however, the first location classification provides a more precise location estimate than the second location classification category.

In an example embodiment, the classification category for wireless device 220 is based on the time of day. For example, wireless device 220 may be classified with a first (e.g. default) priority; however, during certain time periods (for example shift changes), wireless device 220 may be classified with a second priority.

In an example embodiment, the location classification category of wireless device 220 may be dependent on its physical location. For example, wireless device 220 may be associated with a first location classification category while outside area 222; however, wireless device may be associated with a second location classification category while inside area 222.

In an example embodiment, wireless device 220 comprises a battery and the location classification category of wireless device 220 is based on remaining battery life. For example, wireless device 220 is classified in a first location classification category while the battery is at or above a predefined threshold, and is classified in a second location classification category while the remaining battery life is below the predetermined threshold.

In an example embodiment, the predefined condition for determining the location classification category for wireless device 220 may be based on available resources. For example, wireless device 220 may be classified in a first location classification category, however, if location server 220 is insufficient central processor unit (CPU) resources and/or network 204 has insufficient bandwidth available for routing location packets for the first location classification category, location server 202 may send a message to wireless device 220 to switch to a second location classification category that employs less resources. As another example, if wireless device 220 has insufficient resources to implement the first location classification category, wireless device 220 may send data to location server 202 indicating that wireless device 220 is unable to implement the first location classification category. Location server 202 may then select a second location classification category for wireless device 220, or alternatively wireless device 220 may select the second location classification category and may send data representative of the selected location selection category to location server 202.

In an example embedment, wireless device 220 employs a first protocol (or message type) while in the first location classification category and a second protocol while in the second location classification category. For example, if wireless device is associated with AP 206 on first channel and APs 208, 210, 212 are operating on one or more other channels, while in the first location classification category wireless device may employ an 802.11k type protocol and go off channel and listen for beacons or other signals from APs 208, 210, 212 and send data representative of measured signals parameters such as signal strength, Received Signal Strength Indication (RSSI) Angle of Arrival (AOA), etc. to location server 202 that location server 202 can employ for estimating wireless device 220's location. However, while wireless device is classified in the second location classification category, an 802.11v type protocol may be employed where wireless device 220 sends location track notification packets and APs receiving the packets for signal measurements (such as signal strength, RSSI, etc.) to location server 202. In an example embodiment, location server 202 sends a data to wireless device 220 to initiate switch from the first location classification category to the second location classification category.

In an example embodiment, location estimator 104 varies the periodicity for different location classification categories. For example, a first periodicity is employed to estimate the location of the device for the first location classification, and a second periodicity is employed to estimate the location of the device for the second location classification.

In an example embodiment, location estimator 104 employs different algorithms for different location classification categories. For example, a first algorithm is employed to estimate the location of the device for the first location classification, and a second algorithm is employed to estimate the location of the device for the second location classification. The second algorithm may be more computationally intensive or require more storage resources than the first algorithm. For example, the second algorithm may employ maximum likelihood and Kalman filtering algorithms.

In an example embodiment, wireless device 220 may employ a different number of interfaces while classified in the second location category. For example, if area 222 has WiFi and/or BLUETOOTH coverage and wireless device 220 is a cell phone that also has a WiFi and/or BLUETOOTH interface (or any other suitably wireless interface) wireless device 220 may suitably employ the WiFi and/or BLUETOOTH interface while in area 222s. For example, if area 222 is a WiFi hotspot, wireless device 220 may suitably employ a WiFi transceiver while in area 222.

In an example embodiment, location server 202 may change the location classification category of wireless device 220 in response to receiving a request for the wireless device 220's location. For example, if no requests are pending for wireless device's 220 location, a first less precise location estimation technique may be employed by location estimator 104 to determine wireless device 220's location, whereas a second, and more precise, location estimation technique may be employed by location estimator 104 to determine wireless device's 220 location responsive to a request for wireless device 220's location.

In an example embodiment, location estimator 104 may transition wireless device 220 to a second location classification category responsive detecting location jitter (e.g., excessive device movement over a period of time). Location estimator 104 may use a second, more precise technique to determine the location of wireless device 220.

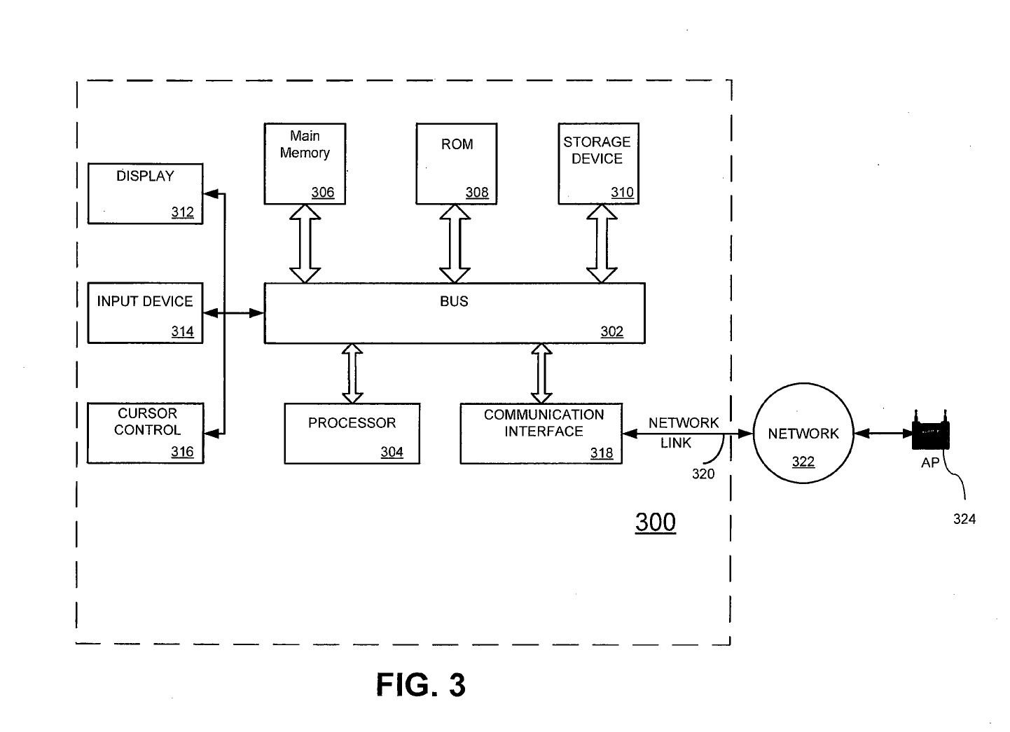

FIG. 3 is a block diagram that illustrates a computer system 300 upon which an example embodiment may be implemented. Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312 such as a cathode ray tube (CRT) or liquid crystal display (LCD), for displaying information to a computer user. An input device 314, such as a keyboard including alphanumeric and other keys is coupled to bus 302 for communicating information and command selections to processor 304. Another type of user input device is cursor control 316, such as a mouse, a trackball, cursor direction keys, and/or a touchscreen for communicating direction information and command selections to processor 304 and for controlling cursor movement on display 312. This input device typically has two degrees of freedom in two axes, a first axis (e.g. x) and a second axis (e.g. y) that allows the device to specify positions in a plane. Input device 314 and cursor control 316 may be employed by a network administrator for entering device classification data.

An aspect of the example embodiment is related to the use of computer system 300 for providing location estimates based on a location classification category. According to an example embodiment, providing location estimates based on a location classification category is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media, and volatile media. Non-volatile media include for example optical or magnetic disks, such as storage device 310. Volatile media include dynamic memory such as main memory 306. As used herein, tangible media may include volatile and non-volatile media. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306 from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling computer system 300 to a network link 320 that is connected to a local network 322. Network link 320 typically provides data communication through one or more networks to other data devices. For example, network link 320 may provide a connection through a local network 322 to an AP 324.

In view of the foregoing structural and functional features described above, a methodology 400 in accordance with an example embodiment will be better appreciated with reference to FIG. 4. While, for purposes of simplicity of explanation, methodology 400 of FIG. 4 is shown and described as executing serially, it is to be understood and appreciated that the methodology is not limited by the illustrated order, as some aspects could occur in different orders and/or concurrently with other aspects from that shown and described herein. Moreover, not all illustrated features may be required to implement methodology 400. Methodology 400 is suitably adapted to be implemented in hardware, software, or a combination thereof. For example, methodology 400 may be implemented by logic 104 in FIG. 1 and/or computer system 300 in FIG. 3.

At 402, a first (e.g., default) location profile is determined for a device. The location profile may be based on the device's configuration, such as supported protocols, remaining battery profile, etc. The location profile may also specify the resources employed for estimating the device's location. The specified resources may suitably comprise any one or combination of periodicity, protocol (type of message), algorithm, number of interfaces employed, etc.

At 404, a determination is made whether a predetermined condition exists. The predetermined condition may be based on any desired criterion. For example, the predetermined condition may be based on the time of day, remaining battery life, current location of the device, available network resources, available device resources, location jitter, ability to communicate with multiple interfaces on the device, and/or any combination of criterion.

If, at 404, a determination is made that at least one predetermined condition has been met (YES), at 406 the device's location is estimated using an alternate location profile. If, however, at 404 a determination is made that no predetermined condition was met (NO), at 408, the default location profile is employed to estimate the device's location. In one example embodiment, the alternate location profile provides a more accurate location estimate. In another example embodiment, the default profile provides a more accurate location estimate. Moreover, different location profiles may differ by one and/or more than one parameter. For example, referring to Table 1, the only difference between L_{—}1 and L_{—}2 is the type of message (protocol) employed for making the location estimate, whereas the differences between L_{—}1 and L_{—}4 are the type of message and the periodicity employed for making the estimate.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
an interface;
a location estimator operable to receive data from a device via the interface;
wherein the location estimator is operable to estimate a location of the device based on data received via the interface based on a first location classification; and
wherein the location estimator is operable to estimate the location of the device based on data received via the interface based on a second location classification while a predefined condition exists.

2. The apparatus set forth in claim 1, wherein the second location classification provides a more precise location estimate than the first location classification.

3. The apparatus set forth in claim 1, wherein the predefined condition is a time of day.

4. The apparatus set forth in claim 1, wherein the predefined condition is when the device is within a predefined area.

5. The apparatus set forth in claim 1, wherein the predefined condition is remaining battery life falling below a predetermined threshold.

6. The apparatus set forth in claim 1, wherein the predefined condition is insufficient resources to provide the estimated location based on the first location classification.

7. The apparatus set forth in claim 6, wherein the device employs a first protocol for providing data for providing the estimated location based on the first protocol; and
wherein the location estimator is operable to send data to the device to change to a second protocol responsive to the predefined trigger.

8. The apparatus set forth in claim 1, wherein a first periodicity is employed to estimate the location of the device for the first location classification, and a second periodicity is employed to estimate the location of the device for the second location classification.

9. The apparatus set forth in claim 1, wherein data is sent to the device by the location estimator via the interface to instruct the device to employ a first protocol to obtain data to estimate the location of the device for the first location classification, and data is sent to the device data is sent to the device by the location estimator via the interface to instruct the device to employ a second protocol to obtain data to estimate the location of the device while the device is in the second location classification.

10. The apparatus set forth in claim 1, wherein a first algorithm is employed by the location estimator to estimate the location of the device for the first location classification, and a second algorithm is employed by the location estimator to estimate the location of the device for the second location classification.

11. The apparatus set forth in claim 1, wherein data associated with multiple interfaces is employed by the location estimator to estimate the location of the device while in the second location classification.

12. The apparatus set forth in claim 1, wherein the location classification for the device is changed to the second location classification responsive to receiving a request for the device's location.

13. A method, comprising:
determining a current location classification for a device;
estimating a current location for the device with a first location estimating technique responsive to determining the device is in a first location classification category; and
estimating the current location for the device with a second location estimating technique responsive to determining the device is in a second location classification category;
wherein the device is determined to be in the second location classification responsive to a predefined event.

14. The method according to claim 13, wherein the device is determined to be in the second location classification category during a predefined time of day.

15. The method according to claim 13, wherein the device is determined to be in the second location classification category responsive to remaining battery life falling below a predetermined threshold.

16. The method according to claim 13, wherein the device is determined to be in the second location classification category while the device is within a predefined area.

17. The method according to claim 13, wherein data for determining the location of the device is acquired using a first wireless protocol while the device is in the first location classification category and data for determining the location of the device is acquired using a second wireless protocol while the device is in the second location classification category.

18. The method according to claim 13, wherein the estimate of the location of the device is based on a first periodicity while the device is in the first location classification category, and the estimate of the location of the device is based on a second periodicity while the device is in the second location classification category.

19. The method according to claim 13, wherein the device is determined to be in the second location classification category responsive to detecting location jitter.

20. Logic encoded in at least one tangible media for execution by a processor and when executed operable to:
employ a first location estimation technique for estimating a location of a device selected from a plurality of location estimation techniques based upon a first location estimation category associated with the device; and
employ a second location estimation technique selected from the plurality of location estimation techniques while a predefined condition exists.
